(19) United States
(12) Patent Application Publication
(10) Pub. No.: US 2010/0062517 A1
(43) Pub. Date: Mar. 11, 2010

(54) In situ production of microbial pigments for metal and actinide immobilization

(75) Inventors: Charles E. Turick, Aiken, SC (US); Anna S. Knox, Evans, GA (US)

Correspondence Address: J. BENNETT MULLINAX, LLC, P. O. BOX 26029, GREENVILLE, SC, 29616-1029, US

(73) Assignee: Savannah River Nuclear Solutions, LLC, Aiken, SC (US)

(21) Appl. No.: 12/584,450

(22) Filed: Sep. 4, 2009

Related U.S. Application Data
(60) Provisional application No. 61/191,053, filed on Sep. 5, 2008.

(51) Int. Cl. A62D 3/02

(52) U.S. Cl. 435/262.5

(57) ABSTRACT

A method is provided which uses existing populations of soil bacteria to produce quantities of melanin and pyomelanin and related pigments which will chemically reduce and chelate metals and sorb to various soil minerals to help immobilize such metals within a subsurface environment. Tyrosene and phenylalanine may be used to generate enhanced levels of melanin.

### RELATED APPLICATIONS

This application claims the benefit of U.S. provisional application No. 61/191,053 filed Sep. 5, 2008, which is incorporated herein by reference.

### STATEMENT AS TO RIGHTS TO INVENTIONS MADE UNDER FEDERALLY SPONSORED RESEARCH AND DEVELOPMENT

This invention was made with Government support under Contract No. DE-AC09-96SR18500 awarded by the United States Department of Energy. The Government has certain rights in the invention.

### FIELD OF THE INVENTION

This invention is directed towards a method of using existing populations of soil bacteria to produce quantities of melanin and pyomelanin. The melanin and pyomelanin serve as a material which will chemically reduce and chelate metals, including uranium (VI) to uranium (IV). The pyomelanin has been found to sorb to soil minerals and when presented with uranium will serve to immobilize the uranium to material within the soil. Further, the resistance of pyomelanin to biodegradation provides a long term immobilization technique for uranium and other metals within a subsurface environment.

This invention relates generally to a process and methodology of using soil bacteria to detoxify and immobilize inorganic contaminants. As used herein, the term “melanin” refers generally to numerous pigments which collectively includes, but are not limited to, eumelanin, pheomelanin, pyomelanin, and allomelanin. These compounds share a common feature of having redox active quinones, which enables them to chemically reduce metals, as well as carboxyl and hydroxyl components that serve as metal chelators. These pigments also have properties similar to well-known humic compounds.

In accordance with the present invention, it has been found that nutritional supplementation of soils by tyrosine or phenylalanine can stimulate the production of melanin pigments by native soil bacteria. As a result of the overproduction of melanin pigments, the soil characteristics may be altered such that the soils have higher redox activity and increased chelating and mineral absorption characteristics. Accordingly, the techniques and methodology described herein provide for a manner of using existing soil bacteria to limit the migration of metals and actinide including the ability to chelate and reduce uranium VI to uranium IV.

### SUMMARY OF THE INVENTION

It is one aspect of at least one of the present embodiments to provide for environmental remediation of metal and actinide contaminated sites.

It is yet a further aspect of at least one of the present embodiments to increase the production by native microorganisms of melanin compounds. The production of melanin by the microorganisms promotes an enhanced redox activity of a large percentage of soil bacteria. The enhanced redox activity provides for an accelerated reduction of contaminants along with increased metal chelating and mineral absorption attributable to the immobilization of metals to soil minerals.

It is yet a further aspect of at least one of the present embodiments to provide for results set forth herein demonstrate the in situ production of melanin, the melanin having the ability to chemically reduce, chelate and immobilize metals within the soil.

It is yet a further aspect of at least one of the present embodiments of the invention to provide for a process of immobilizing metals and actinides within a soil comprising the steps of increasing the production of melanin and pyomelanin by nutritional supplementation of soil bacteria, said melanin and pyomelanin being produced in excess and released into the environment surrounding said soil bacteria;

providing an enhanced chemical reducing environment as a result of excess melanin pigments;

chelating metals and actinides in a soil using the excess pyomelanin released by the soil bacteria, said chelating step further including sorbing said pyomelanin to a soil mineral; and

contacting a metal or actinide with said sorbed pyomelanin, thereby immobilizing said metal or actinide within the subsurface.

These and other features, aspects, and advantages of the present invention will become better understood with reference to the following description and appended claims.

### BRIEF DESCRIPTION OF THE FIGURES

FIG. 1 sets forth FTIR Spectra from pore water one month following the addition of tyrosine.

FIG. 2 sets forth FTIR Spectra of tyrosine and DOPA-melanin in showing characteristic bands of soil effluents following 30 days incubation with tyrosine.

FIG. 3 sets forth a graph setting forth pore water uranium concentrations comparing tyrosine treated soil compared to controls.

FIG. 4 is a graph depicting uranium interactions with pyomelanin at various concentrations and pH.

FIG. 5 is a graph setting forth comparison of pyomelanin sorption to goethite and illite.

FIG. 6 is a graph setting forth uranium sorption to minerals as a function of pyomelanin concentration.

FIGS. 7 and 8 are graphs setting forth metal concentrations for water sorption following one month of treatment in thirteen months time intervals.

### DESCRIPTION OF THE PREFERRED EMBODIMENT

Reference will now be made in detail to the embodiments of the invention, one or more examples of which are set forth below. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used on another embodiment to yield a still further embodiment. Thus, it is intended that the present invention cover such modifications and variations as come within the scope of the appended claims and their equivalents. Other objects, features, and aspects of the present invention are disclosed in the following detailed description. It is to be understood by one of ordinary skill in the art that the present discussion is a description of exemplary embodiments only and is not intended as limiting the broader aspects of the present invention, which broader aspects are embodied in the exemplary constructions.

Detailed methodology and processes directed to the in situ production of microbial pigments such as melanin compounds which can be used for metal and actinide immobilization are described in articles authored by the present inventors. The articles include “In situ uranium stabilization by microbial metabolites”, published in the Journal of Environmental Radioactivity 99 (2008) 890-899 which is incorporated in its entirety by reference herein. An additional article entitled, “Pyomelanin is produced by Shewanella algae BrY and affected by exogenous iron”, Canadian Journal of Microbiology, Vol. 54, 08, page 334-339 and which is incorporated hereby by reference in its entirety.

In accordance with this invention, it has been found that the microbial of humic-type compounds can be stimulated and enhanced and thereby provide for an increase capability of metal sorption within a variety of soils. The classes of pigments known as melanins are humic-type compounds and are the among the most common pigments produced in nature. Humics play a significant role in metal immobilation by binding two metal oxides and complexing with soluble metals.

In accordance with invention, it has been found that by enhancing microbial melanin production by indingious micro-organisms within contaminated soil, the increased melanin production greatly enhanced the soils ability to increase the amount of uranium immobilization in uranium-contaminated soil. Further, it has been found that the significant levels of uranium immobilization which occur are persistent by a resistant degradation and thereby contribute to uranium immobilization for extended time periods.

### Materials and Methods

Soil Properties and Analysis

The Tims Branch watershed makes up a portion of SRS and parts of this watershed have been impacted in the past with uranium (U) contamination. Soil samples representative of this watershed were collected aseptically and immediately stored on ice until delivery to the laboratory. Soil samples were then refrigerated until processing. These soils were quantified for melanin producing bacteria and U concentration as reported below.

Additionally, the following soil properties were analyzed: percent organic matter by loss-on-ignition at a temperature of 375° C. and pH was determined from a 1:1 mineral/water equilibration solution. Also, total concentration of U in a homogenized soil sample was determined by a total microwave digestion of 0.6 g of homogenized soil material with concentrated acids (10 ml of HNO₃, 4 ml of H₂SO₄, and 2 ml of HCl). The resulting extract solution was analyzed by ICP-MS.

Enumeration of Pigment-Producing Microorganisms from Soil

To enumerate pigment producing microorganisms, the soil from Tims Branch, SRS was diluted (10⁻²-10⁻⁸) with lactate basal salt medium (LBSM) supplemented with 1 g/l tyrosine as set forth in Turick, C. E., Tisa, L. S., Caccavo, F. Jr., 2002. Melanin production and use as a soluble electron shuttle for Fe(III) oxide reduction and as a terminal electron acceptor by Shewanella algae BrY. Applied and Environmental Microbiology 68, 2436-2444, and which is incorporated herein by reference. While tyrosine was utilized in the data obtained herein, phenylalanine may also be used to generate enhanced levels of pyomelanin and achieve similar results. Additional details on environmental production of pyomelanin can be further seen in reference to the article The Role of 4-Hydroxyphenylpyruvate Dioxygenase in Enhancement of Solid-Phase Electron Transfer by Shewanella Oneidensis MR-1 in FEMS Microbial Ecology 68 (2009) 223-235, and which is incorporated herein by reference.

Controls (untreated soil) received the same treatment except tyrosine was omitted. Each tube of the 3 tube most probable number (MPN) assay contained 10 ml of growth medium and soil and was incubated for 8 weeks at 25° C. and shaken at 100 rpm. Increased pigmentation as a result of tyrosine amendments was determined spectrophotometrically by scanning the supernatant fluid of each test tube from 600-300 nm. Tubes with increased absorbance in this range, relative to controls were marked positive for pigment production from tyrosine. The number of positive tubes per dilution was used to calculate the most probable number of pigment producing cells/g soil. Samples were removed aseptically from the soil MPNs and inoculated onto tryptic soy agar supplemented with tyrosine (2 g/l) (TSAT), using the spread plate method. Following incubation at 25° C. for 1 week, colonies demonstrating pigmentation (relative to plates without tyrosine) were transferred from TSAT to LBSM agar with and without 2 g/l tyrosine and monitored for pigmentation. Pigment production was determined by comparing coloration from tyrosine amended plates relative to those without tyrosine.

Characterization of Microbial Pigment

Initial characterization of pigment included intensity of coloration and diffusion through agar media. Dark black non-diffusive pigments are indicative of DOPA melanin whereas reddish brown diffusive pigments are more likely pyomelanin. The chemical sulcotrione (Zeneca Agrochemicals) was used as a specific competitive inhibitor of 4-HPPD, the enzyme required for pyomelanin production. Methods incorporated sulcotrione to determine if pigment production was a result of 4-HPPD. Pure cultures of soil isolates were grown in LBSM and tyrosine (1 g/l) was supplemented to promote pigment production. Sulcotrione (18 μM) was added prior to pigmentation in order to differentiate pyomelanin production from other pigments that may be produced. Pigment production was quantified spectrophotometrically (400 nm) in cell free culture fluid. Controls for comparison were without tyrosine or without sulcotrione.

Changes in the organic content of soils due to pyomelanin production were also determined by spectrophotometric absorbance (400 nm) of particle free supernatants and Fourier transform infrared (FTIR) spectroscopy. Soil samples were removed (5-10 g/column) 28 days after treatment addition for pore water analysis. Optical density was determined for centrifuged soil to determine the degree of pigmentation resulting from tyrosine amendments. Dried pigments from soil effluents (60° C.) were then further characterized using FTIR spectroscopy and compared to that of pure tyrosine and dihydroxyphenylalanine (DOPA) melanin (Aldrich Chemicals). Bacterial pyomelanin used for FTIR characterization was obtained as described previously in Turick et al, 2002. FTIR spectra were collected using a ThermoElectron Nicolet 4700 Fourier transform infrared spectrometer equipped with a DTGS detector. All samples were analyzed using a ThermoElectron Smart Orbit diamond single bounce attenuated total reflectance accessory. All spectral manipulation and analysis (i.e., baseline correction, band height determination, peak frequency determination) was performed in either the Omnic/Version 7.1a (Thermo Electron Corporation, Madison, Wis.) or GRAMS 32/Version 5.01 (Galactic Industries Corporation, Nashua, N.H.) software programs.

Soil Column Construction

Soil columns were constructed to facilitate field testing of the methodology. These columns were constructed to allow rainfall to leach through the columns and be collected for analysis at different depths and at the discharge.

At the field site, a pit was dug by hand to facilitate installation of the soil columns. Soil from the pit was homogenized and cleaned of any roots or other debris. This homogenized, native soil was then placed in the inner housing of each soil column.

After the inner housings were filled with the native soil, lysimeters (Soil Moisture Equipment Corp. Rhizon lysimeters) were installed at three different depths (10, 30 and 50 cm) by inserting them through predrilled holes perpendicular to the long dimension of the housing. Each lysimeter consisted of a 10 cm porous polymer tube connected to a 10 cm PVC tube and male Luer-Lock connector for pore water sampling. Lysimeters were attached to the top of the soil column using color coded nylon tubing. For each soil column, the inner housing was then placed inside the outer housing.

After the lysimeters were installed, the annulus between the inner and outer housing was filled with clean sand. Nylon tubing was connected to a predrilled hole in the bottom of the outer housing and extended to the top of the soil column. This allowed for the collection of the leachate exiting the inner housing. A protective cap with holes to allow for rainfall infiltration was fitted to the top of the inner housing of each soil column. A cover was placed over the annulus between the inner and outer housing to prevent rainfall infiltration.

After assembly, the soil columns were placed in the pit and void space between the soil columns was then filled with the remaining soil from excavation. Metal sheeting was used to protect the soil columns from animal damage.

Treatment Conditions

Soil columns remained untreated for 2 months to allow for settling and periodic lysimeter checks. Sterile amendments were added to numbered columns chosen randomly for each treatment on Aug. 3, 2005. Twenty four hours prior to sampling, excess water was removed from the soil columns with a peristaltic pump attached to the tubing connected to the bottom of the outer housing of the soil columns. Triplicate treatments included tyrosine (2 g/kg soil) (10 mM), and 100 ml sterile DI water. Sterile DI water alone served as the control. One kg of soil constituted approximately 30% of the volume of each field column.

Leachate and Soil Analyses

Throughout the 28 days of incubation the top 5 cm of soil of each column was mixed with sterile plastic spatulas on day 7 and 14, to assist tyrosine mixing and solubility. During field incubation rainfall was measured at 12.1 cm. After incubation soil pore water was obtained from each lysimeter (three depths per column). Samples were removed from soil by fitting each lysimeter with a 18 gauge hypodermic needle and inserting the needle into a negative-pressure, gas-tight test-tubes. The negative pressure in each 10 ml test tube pulled pore water from the soil at the lysimeters soil depth. Pore water samples were stored immediately on ice until overnight storage in the lab at 4° C. Samples were processed the next day and analyzed for metals and pH.

Changes in organic matter content of soils as a result of tyrosine treatments were determined as described above.

Laboratory studies of pyomelanin complexation with U, goethite and illite.

Bacterial pyomelanin was concentrated and dialyzed from culture as described in Turick et al., 2002 stored as a stock solution in HEPES buffer (pH 7 and pH 4). Various pyomelanin dilutions were incorporated into binding studies with U and sorption studies with goethite (Alfa Aesar) and illite (Clay Minerals Society) at pH 4 and pH 7. For U binding studies, desired amounts of pyomelanin stock were added to 15 ml of HEPES buffer (pH 4 and pH 7) containing 100 μg/l U (uranyl nitrate, Sigma Chemicals). The solutions were shaken in sealed polypropylene vials at 150 rpm at 25° C. for 7 days prior to analysis. U concentrations unbound to pyomelanin were measured by removing the pyomelanin through centrifugal concentration (5000 rcf for 1-2 h) with 5 kDa dialysis membranes. Clear, pyomelanin-free liquid was analyzed for U with ICP/MS. U binding to the dialysis membrane units was not detected.

Pyomelanin sorption studies with goethite and illite (10 mg/ml) were conducted in 15 ml HEPES buffer (pH 4 and pH 7). Pyomelanin concentrations and incubation were as above. Pyomelanin sorption was determined through optical density measurements (400 nm) of the centrifuged samples (5000 rcf for 30-45 min.) and correlated with known pyomelanin standards.

Illite was chosen as a representative clay mineral based on cation exchange capacity and specific surface area. The cation exchange capacity for mica-like mineral (illite) is 20-40 meq/100 g, for vermiculite 127 meq/100 g, and for kaolinite 1-11 meq/100 g. Specific surface area for illite is slightly larger than for mica (70-120 m²/g), and kaolinite 5-20 m²/g.

Interactions with U, pyomelanin and goethite or illite were conducted as above for the mineral studies. U concentrations were determined with ICP-MS.

Results

Enumeration of Pigment-Producing Microorganisms from Soil

Bacterial densities of pigment producers from soil samples of the study site demonstrated MPN values of 1.1×10⁶ cells/g wet wt of soil. Pigment production was evident with tyrosine treatments but not controls. Dilutions (10⁻¹) of soil-free pore water (from 5 cm cores) effluents demonstrated a significant increase in pigmentation one month after tyrosine addition, with an average absorbance (OD₄₀₀) of 1.78 (SD=0.6) for tyrosine treated soils compared to an absorbance of 0.01 for controls.

Characterization of Microbial Pigment

Extracellular bacterial pigmentation was evident on TSAT and LBSM plates with tyrosine 48-72 h after inoculation and increased in intensity for several weeks. The pigment was reddish-brown in color and diffused throughout the agar. DOPA melanin would be expected to be dark back in color and diffuse poorly in agar. Pigment production was halted in bacterial cultures with sulcotrione, relative to pigment production without the inhibitor (data not shown), indicating that pyomelanin was the pigment produced.

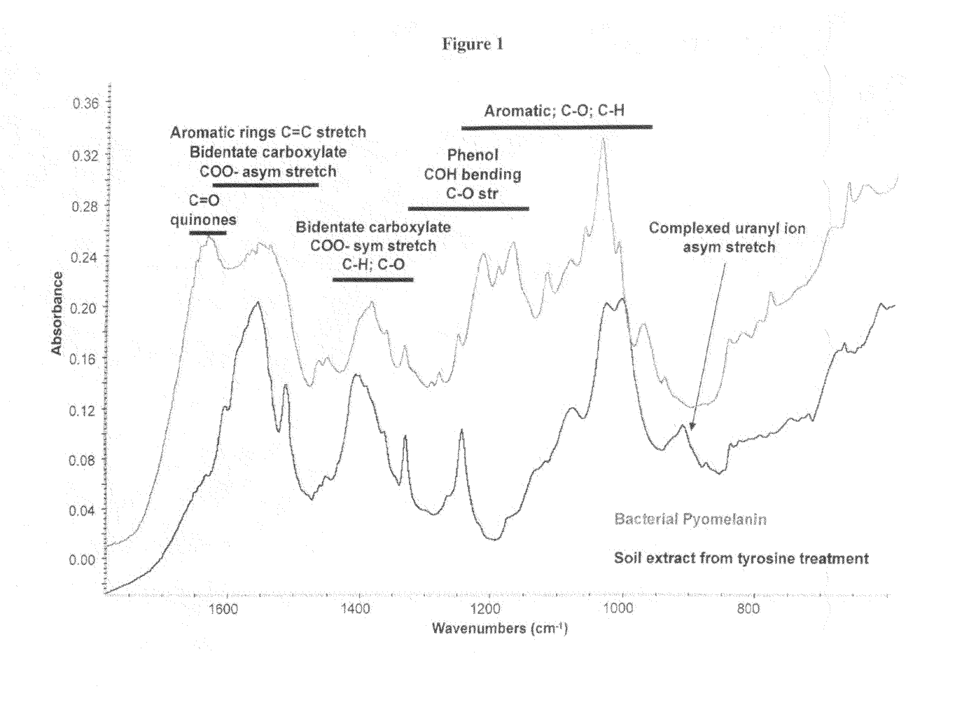

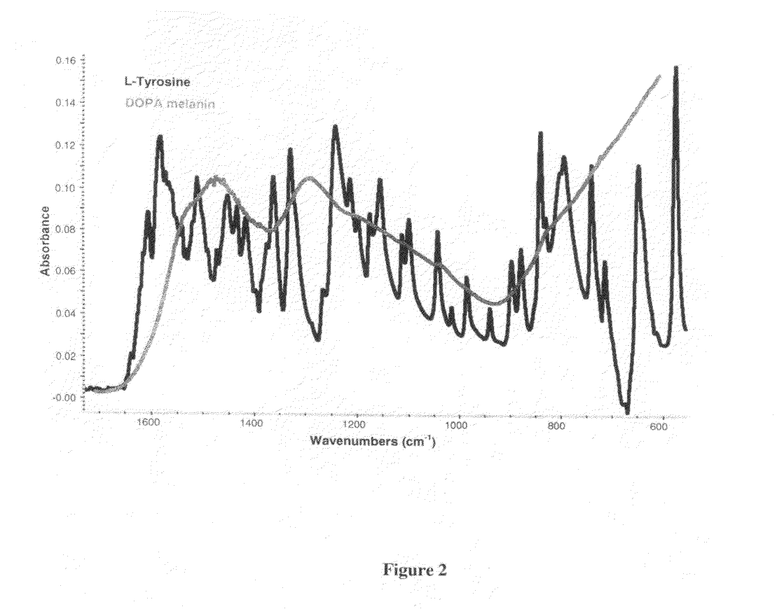

Effluents from soils incubated for 30 days with tyrosine were analyzed to determine if differences existed in FTIR response relative to treatments. Tyrosine amended soils demonstrated spectral similarities with pyomelanin (FIG. 1) and spectral differences with pure tyrosine and DOPA melanin (FIG. 2), thus demonstrating the potential of FTIR spectroscopy to discriminate between pyomelanin and other related compounds. The spectral similarities observed between bacterial pyomelanin and tyrosine amended soils occurred at frequencies corresponding to literature reports of aromatic rings, phenolic OH groups, and C—O bonds associated with alcohols although complete spectral interpretation in this region is difficult due to overlap of frequencies from multiple functional groups. The primary spectral differences observed between bacterial pyomelanin and the tyrosine amended soils were a decrease in spectral bands around 1630 cm⁻¹ and in the spectral range from 1100-1250 cm⁻¹ as well as intensity differences at 1410 cm⁻¹ and 1560 cm⁻¹ between the spectra, respectively. The former is attributed to changes in C═O, C—O, and OH groups, of which some of these bands are associated with carboxylic groups. The increase in intensity for the spectral bands at 1410 cm⁻¹ and 1560⁻¹ for the tyrosine amended soil samples may be attributed to carboxylate complexes with heavy metals. The 1410 cm⁻¹ band is tentatively assigned to the symmetric COO⁻ stretch, while the band at 1560 cm⁻¹ is assigned to the asymmetric COO⁻ stretch of the carboxylate. These assignments are consistent with the presence of a bidentate carboxylate complex with a metal. Another key spectral difference observed in the tyrosine amended soil samples compared to bacterial pyomelanin is a spectral band present between 900 and 950 cm⁻¹. This band may be attributed to the asymmetric uranyl ion stretch, νₐ(UO₂). As ligands, such as carboxyl groups, complex with the uranyl ion, the O═U═O bond weakens and the bond length increases. These bond strength differences are attributed to the strength of the ligand binding in the equatorial plane of the uranium center. As ligands bind in this preferred geometry, the electron density on the uranium atom increases causing electrostatic repulsion with the extremely electronegative oxygen atoms. This weakens the O═U═O bond and causing a shift to lower wavenumber of the asymmetric stretch. The frequency of the uranyl band observed in the tyrosine amended soil samples is consistent with that described for complexed uranyl species.

Leachate Analyses

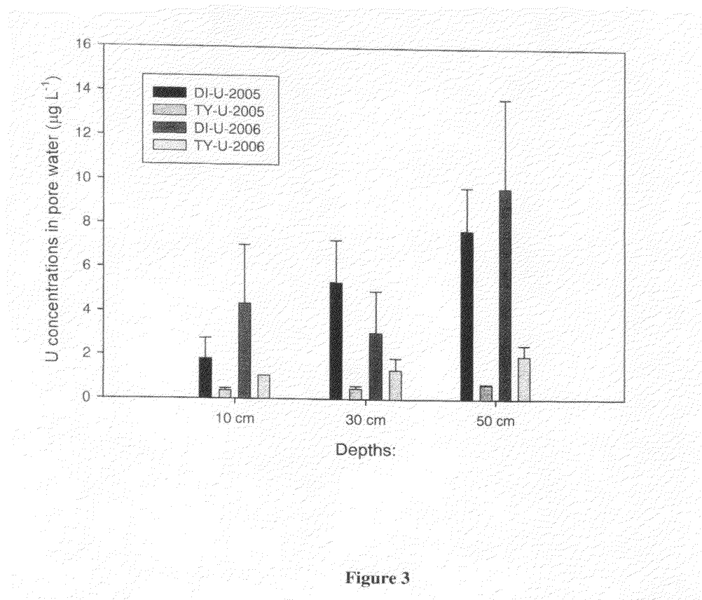

Pore water samples taken 30 days after treatments, from 10, 30 and 50 cm depths demonstrated significantly decreased U in tyrosine treated soils compared to controls (FIG. 3). U concentrations in pore water were only slightly higher one year after tyrosine amendments occurred, indicating a capacity for U immobilization for an extended time. Pore water from any depth sampled of tyrosine amended soil was not pigmented. This is in contrast to surface soils of the same treatments one month after tyrosine was applied.

Soil Analysis

Following tyrosine additions, organic matter content of tyrosine amended soil was 1.76% compared to 1.14% for untreated soil (P<0.1). The pH values did not change significantly over time nor with treatment conditions. For soil depths of 10 and 30 cm, pH was 4.2(±0.3) and for 50 cm depth, pH values were 5.0(±0.3).

Laboratory Studies of Pyomelanin Complexation with U, Goethite and Illite

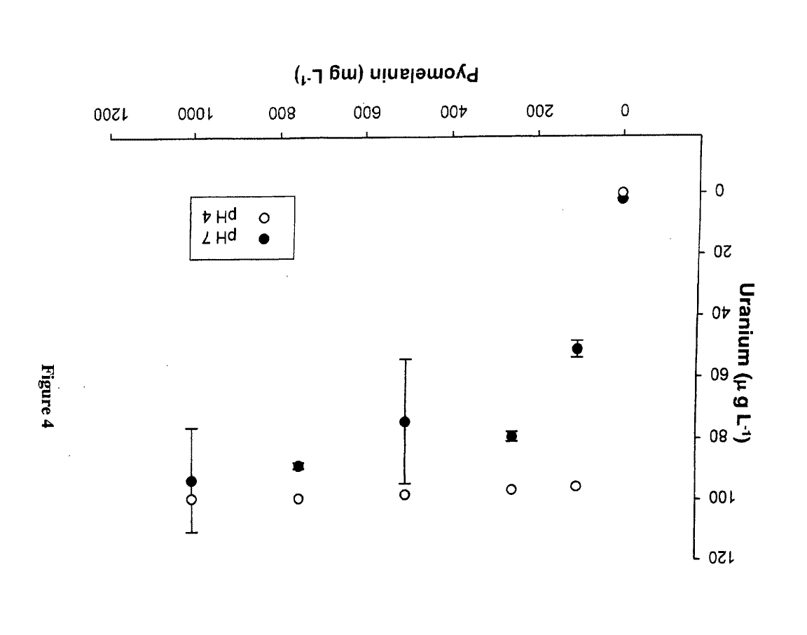

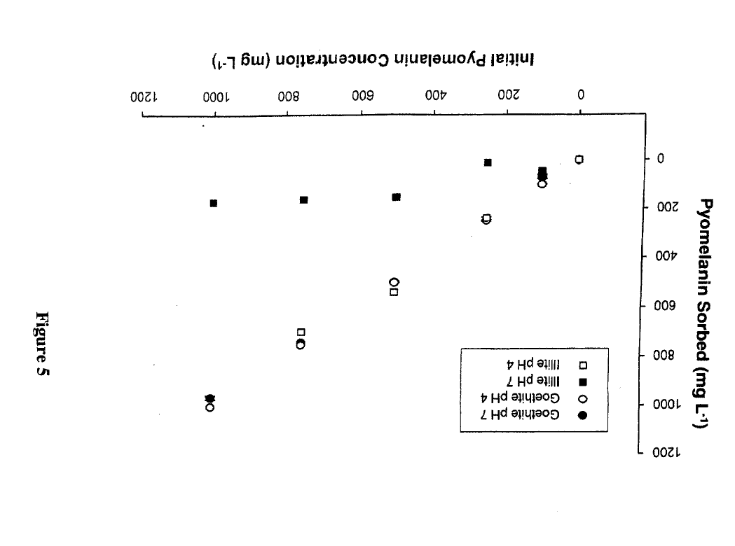

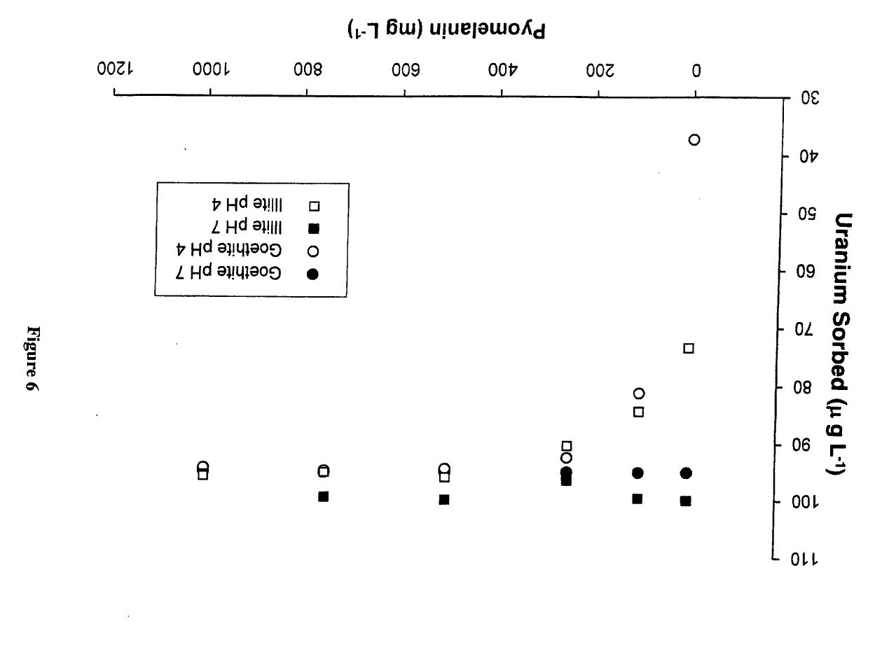

Pyomelanin demonstrated the ability to complex U as a function of pH and pyomelanin concentration (FIG. 4). Nearly complete complexation of the 100 μg/l spike at pH 4 took place with all pyomelanin concentrations analyzed. Pyomelanin demonstrated complete adsorption to geothite at both pH 4 and pH 7 and illite at pH 4 (FIG. 5). Adsorption also occurred with illite at pH 7, albeit to a lesser degree than that of pH 4. U adsorption to goethite and illite at pH 4 was enhanced in the presence of pyomelanin compared to samples without pyomelanin (FIG. 6). At pH 7, U sorption to goethite and illite was complete in the absence of pyomelanin (FIG. 6). The amount of U sorbed at pH 7 did not decrease as a function of increasing pyomelanin concentrations, indicating that pyomelanin was not detrimental to U-mineral sorption at this pH.

The tendency of U to sorb to soils is controlled by a number of environmental factors, such as oxidation states, pH, and mineralogy. Tims Branch soil is characteristic of the highly weathered soils of the Atlantic Coastal Plain, with 20% sand, 45% silt, and 35.6% clay. In the sand fraction the main minerals are quartz and feldspar. In the silt fraction the main minerals are quartz, kaolinite, and feldspar. The clay fraction is composed mostly of kaolinite, hydroxyl-interlayered vermiculite, gibbsite, quartz, and goethite. The soils tend to be acidic (pH 4.0-4.5) with variable low levels of organic carbon.

The quantity of pigment producing bacteria determined through MPN assays from soil at the study site demonstrated potential for melanin production in-situ. Tyrosine amended soils and pure cultures from the study site confirmed this, and resulted in pyomelanin production as the most abundant pigment produced, as determined by growth observations, enzyme inhibitor studies and FTIR analysis.

Pyomelanin was abundant in surface soils of tyrosine treatments, but absent in pore water at 10-50 cm depths from the same treatments throughout the study. The lack of pigmentation at depth indicated pyomelanin sorption to soil. Laboratory studies with pyomelanin confirmed complete pyomelanin sorption to iron minerals at pH 4 and pH 7 as well as complete sorption to clay at pH 4. The laboratory studies demonstrated the high probability of pyomelanin sorption to iron and clay minerals in the pH 4 soils of the study site. Humic sorption to mineral surfaces increases as pH decreases due to pH dependant characteristics of the surface charge of the solids as well as the solution charge of the humics. In this study, pyomelanin behaved in a similar manner with a greater degree of sorption to illite at the lower pH. The similarities of pyomelanin sorption to goethite at pH 4 and 7 may be due to an abundance of sorption sites, such as hydroxyl groups on the goethite surface.

Uranium complexation with pyomelanin was also demonstrated in the laboratory with nearly 100% of U associated with pyomelanin in all concentrations studied at pH 4. The ability of pyomelanin to complex with U and also sorb well to clay and iron minerals at pH 4 was further demonstrated in laboratory studies, with significant increases of U associated with goethite and illite in the presence of pyomelanin.

Field studies corroborated the laboratory results with significant U immobilization in pore water from tyrosine amended soils. The low U concentrations in pore water more than one year after tyrosine addition to the soil indicated that pyomelanin, a humic-type compound, is resistant to degradation and thereby contributed to U immobilization for an extended time. FTIR spectral differences between bacterial pyomelanin and tyrosine treated soils indicate that carboxyl groups contribute significantly to U binding by this bacterial metabolite.

The present invention demonstrates the physiological potential of subsurface bacteria to produce metabolites capable of U sequestration for extended periods. The one-time addition of tyrosine to soil exploited the ability of indigenous microbes to produce pyomelanin, resulting in U immobilization for at least 13 months. This approach offers the potential to rapidly increase the abundance of humic-type microbial metabolites in-situ, through the addition of melanin precursors such as tyrosine. While U concentrations utilized herein were relatively low, humics have a much greater U binding capacity. Consequentially, the approach presented here is expected to be applicable in soils with higher U concentrations. A significant advantage may be the ability to control the amount of humic material produced to achieve optimal contaminant sequestration. Similarities between microbial melanin and other humic compounds suggest that microbial melanin will also be useful in immobilization of other metals, especially in soils with pH values ranging from acidic to neutral.

Pyomelanin is typically produced by soil bacteria under low oxygen conditions. Where desired, anaerobic conditions can be easily established as well known in the art by providing a carbon source such as lactate. Providing lactate in condition with either tyrosine or phenylalanine can be used to produce melanin pigments under anaerobic conditions. As is generally known, pyomelanin may be used as a conduit for electron flow from bacteria to metals.

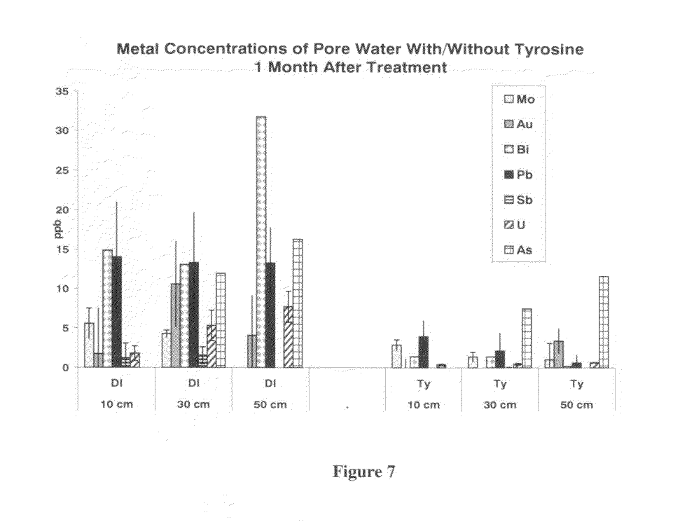

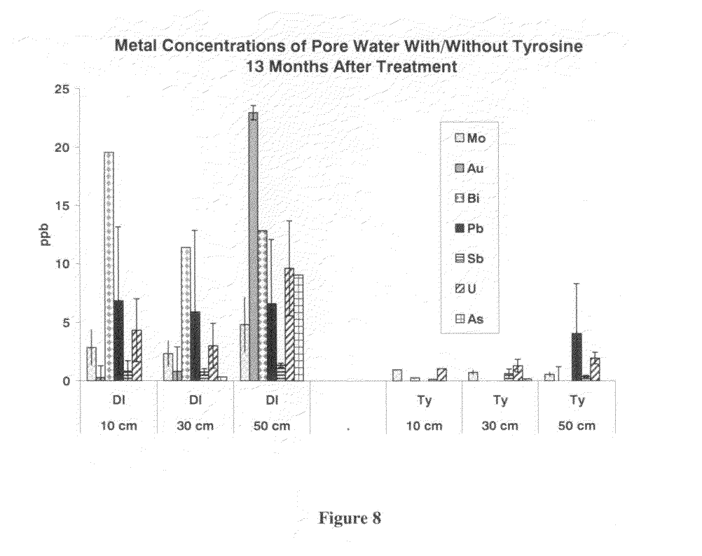

While the onset of anaerobic conditions can be the most effective way of enhancing the production of melanins, metal binding capacities of melanin within soils occurs irrespective of the anaerobic conditions. Of the data set forth above provides finding absorption activity for Uranium to the melanin used by microbial organisms, it is believed that similar binding results will occur for any number of divalent metals that typically are found in soil environments or contaminated soil environments. As defined herein, divalent metals refers to metals having a +2 charge and includes metals and metal compounds that have a divalent form. As set forth in FIGS. 7 and 8, the ability of the melanin pigments to bind various divalent metals is set forth. In comparison to both the controls and in comparison to the time intervals set forth therein, the microbial produced melanin provides an ability to promote long-term binding of various metals within a treated soil environment. The FTIR data demonstrate that U is bound by soil pigments. The U is tethered to soil particles by melanins since though U is traditionally considered very mobile in soil or water.

The process described above provides a useful treatment process by using soil bacteria to produce an excess of melanin, which, when released, is sorbed to minerals. Once sorbed, the melanin will additionally immobilize metals such as uranium and other divalent metals. The process can also be used by the soil inoculation of appropriate melanin producing bacteria along with appropriate nutritional supplementation such as tyrosine. The process further lends itself to use a bioreactor or above-ground treatment of contaminated soils.

Although preferred embodiments of the invention have been described using specific terms, devices, and methods, such description is for illustrative purposes only. The words used are words of description rather than of limitation. It is to be understood that changes and variations may be made by those of ordinary skill in the art without departing from the spirit or the scope of the present as is set forth herein. In addition, it should be understood that aspects of the various embodiments may be interchanged, both in whole, or in part. Therefore, the spirit and scope of the invention should not be limited to the description of the preferred versions contained therein.

That which is claimed:

1. A process of immobilizing metals and actinides within a soil comprising the steps of:
increasing the production of melanin by nutritional supplementation of soil bacteria, said melanin being produced in excess and released into the environment surrounding said soil bacteria;
providing an enhanced chemical reducing environment within said soil as a result of an excess of said melanin pigments;
chelating metals or actinides in a soil using the excess pyomelanin released by the soil bacteria.

2. A process according to claim 1 wherein said melanin being produced is a pigment selected from the group consisting of eumelanin, pheomelanin, pyomelanin, allomelanin and combinations thereof.

3. The process according to claim 1 wherein said step of increasing the production of melanin further comprises the step of soil supplementation by tyrosine.

4. A process of chemically reducing uranium (VI) to uranium (IV) comprising the steps of:
providing a soil containing uranium (VI);
increasing the production of melanin by nutritional supplementation of soil bacteria by providing tyrosine to soil bacteria, thereby having said soil bacteria produce melanin in excess, said excess melanin being released into the environment surrounding soil bacteria;
reducing said uranium (VI) to a uranium (IV) by the formation of complexes between melanin and uranium (VI).

5. A process according to claim 1 wherein said chelating metals are divalent metals.

6. The process according to claim 1 comprising the additional step of additionally binding said pyomelanin containing metals or actinide to an iron or a clay mineral surface, thereby immobilizing said metal or actinide within the subsurface.
